(19) United States
(12) Patent Application Publication
(10) Pub. No.: US 2020/0046610 A1
(43) Pub. Date: Feb. 13, 2020

(54) System for Producing Pharmaceutical Tablets

(71) Applicant: L.B. Bohle Maschinen und Verfahren Gesellschaft mit beschränkter Haftung, Ennigerloh (DE)

(72) Inventor: Lorenz Bohle, Ennigerloh (DE)

(21) Appl. No.: 15/775,011

(22) PCT Filed: Sep. 7, 2017
(86) PCT No.: PCT/EP2017/001057

§ 371 Date: May 10, 2018

(30) Foreign Application Priority Data
Oct. 6, 2016 (DE) 20 2016 105 585.7

(51) Int. Cl. A61J 3/00; A61J 3/10; B30B 11/00; B30B 11/34; B30B 15/00

(52) U.S. Cl. CPC A61J 3/005; A61J 3/10; B30B 15/0082; B30B 11/34; B30B 11/005

(57) ABSTRACT

The invention relates to a method for producing pharmaceutical tablets, in which method pressed tablet articles are formed and given a coating, wherein the pressed tablet articles are, before they are given a coating, stored in an intermediate storage area (10) for a product-specific hardening period and are then automatically removed from the intermediate storage area (10) for further processing, wherein a system control unit (17), in which the product-specific hardening periods can be or are stored, detects the time at which the pressed tablet articles are placed into the intermediate storage area (10) and once the product-specific hardening period has come to an end, initiates the automatic removal of the pressed tablet articles. The invention further relates to a system for producing pharmaceutical tablets, having at least one tablet press (2) and at least one coater (14), which is arranged downstream of the tablet press (2) and which gives the pressed tablet articles formed in the tablet press (2) a coating, wherein the system has containers (8), which are configured to receive the pressed tablet articles ejected from the tablet press (2), the system comprises an intermediate storage area (10) having at least two storage spaces (11), the system has a handling system (9) that brings the containers (8) to the intermediate storage area (10) and removes them therefrom, and the system comprises a system control unit that controls the handling system (9), wherein in the system control unit (17), product-specific hardening periods can be or are stored and the system control unit (17) detects the content of a container (8), the storage space (11) assigned to a container (8) in the intermediate storage area (10), and the start of the hardening period and, once the hardening period has come to an end, actuates the handling system (9) to remove the corresponding container (8) from the intermediate storage area (10) and to transport it for further processing.

Subject matter of the invention is a method for producing pharmaceutical tablets in which compressed tablets are compressed and provided with a coating, as well as a system for performing the method.

A method of the aforementioned kind as well as systems for performing the method are known in practice. In known methods and systems, the compressed tablets after the compression step are discharged immediately to a coater in order to coat the compressed articles with the coating. In this context, product-specific properties of compressed articles cannot be taken into consideration which may cause quality defects in the produced tablets.

Object of the invention is to provide a method as well as a system for performing the method with which high-quality tablets can be produced.

This object is solved by a method in which the compressed tablets, prior to their being provided with a coating, are stored in an intermediate storage area for a product-specific hardening period and, subsequently, removed automatically from the intermediate storage area for further processing. In this context, a system control unit, in which product-specific hardening periods are stored or can be stored, detects the point in time of introducing the compressed tablets into the intermediate storage area and initiates at the end of the hardening period the automatic removal of the compressed tablets. In this way, a completely automated, quasi continuous production of high-quality tablets is enabled because the coating is applied in the coater to the compressed articles only once they have hardened optimally in regard to product specifications.

Namely, compressed tablets after they have been compressed can still be comparatively unstable and/or can undergo size changes by expansion or shrinkage. This constitutes a problem for a continuous or quasi continuous production of pharmaceutical tablets in which the compressed tablets after compression are to be provided with a coating. On the one hand, these compressed tablets after compression may not be sufficiently stable for further processing so that they break or even disintegrate completely. On the other hand, the compressed tablets after they have been provided with a coating can experience expansion or shrinkage. When the changes of the dimensions of the compressed tablets, which form the tablet core in the coated pharmaceutical tablets, are greater than the change that can be compensated by the elasticity of the coating, it may happen that cracks form in the coating. Such cracks are in particular markedly problematic in case of functional coatings that are to effect, for example, a release of an active ingredient of the tablet in the small intestine but not yet in the stomach of a living being to be treated.

In the method according to the invention, the compressed tablets are stored for a hardening period in an intermediate storage area. Here, the compressed tablets can harden completely. They reach here their final size and exhibit subsequently the required mechanical strength. Depending on the composition of the compressed tablets, the required hardening period can amount to a few minutes up to several hours. The hardening periods are thus product-specific.

At the end of this product-specific hardening period, the compressed tablets are removed from the intermediate storage area and supplied to further processing. This takes place automatically, controlled by a system control unit.

The product-specific hardening periods are stored in the system control unit, or are input therein. Moreover, it is conceivable that the originally stored hardening periods for a certain product are changed in the context of an adaptation or optimization. The system control unit detects the point in time of introduction of the compressed tablets into the intermediate storage area and initiates the automatic removal of the compressed tablets at the end of the hardening period. In this context, system-specific operating parameters such as occupancy state of coater, occupancy state of intermediate storage area, and the like are and/or can be taken into consideration.

In an advantageous embodiment of the method, the compressed tablets with identical hardening period are introduced into a container and the container is transferred by a handling system into the intermediate storage area. Combining compressed tablets with identical hardening period in one container simplifies the method. Accordingly, it is not required to keep track of the hardening period of the individual compressed tablets but a common hardening period for the compressed tablets in a container can be kept track of in the system control unit. The automatic transfer of the compressed tablets into the intermediate storage area as well as the automatic removal are also facilitated when the tablets are combined in one container. An automatic handling system can thus be optimized for handling a defined article, here a container.

Advantageously, the method provides that the container is transferred onto one of at least two storage spaces in the intermediate storage area wherein the system control unit detected the container contents and the storage location in the intermediate storage area. At the end of the stored product-specific hardening period, the container, controlled by the system control unit, is automatically removed by the handling system from the storage location in the intermediate storage area. Since the container contents as well as the storage location of a container in the intermediate storage area are recorded in the system control unit, several containers can be stored in an intermediate storage area. The required size of the intermediate storage area results from the speed with which the compressed tablets can be compressed or the speed with which the compressed tablets can be coated with a coating as well as the product-specific hardening period.

Preferably, the container removed from the intermediate storage area is docked to an inlet opening of a coater and the compressed tablets are emptied from the container into the coater. In this way, emptying of the container into a coater can also be performed automatically.

Advantageously, compressed tablets with different hardening period are stored in the intermediate storage area at the same time. In this way, the method enables processing of different types of compressed tablets. Those compressed articles whose hardening period has elapsed are removed from storage and supplied to subsequent processing. This increases, on the one hand, the flexibility and, on the other hand, the utilization of a corresponding process or of a system performing the method. This is in particular valuable when different products are to be produced and a changeover is to take place. In this context, in the intermediate storage area tablets of one product are still contained in the intermediate storage area while already compressed tablets for a different type of tablet are being compressed and also pout into storage in the intermediate storage area. Moreover, this is advantageous when several tablet presses and/or several coaters are assigned to a common intermediate storage area. It is particularly advantageous when the different compressed tablets remain in the intermediate storage area for hardening periods of different lengths.

Advantageously, the production of the compressed tablets is realized continuously at least in parts. In this context, on the one hand, compression of the tablets or, on the other hand, coating of the compressed tablets with a coating can be realized continuously. It is also possible that compression as well as applying a coating are performed continuously. This applies as least until for compression of the tablets or for providing the compressed tablets with a coating a change of the respective product to be processed occurs.

Preferably, dust is removed from the compressed tablets. This makes it easier to reliably apply a coating to the compressed tablets. Moreover, by means of dust removal of the compressed tablets, it is prevented that dust produces flaws in the coating.

The object is furthermore solved by a system for producing pharmaceutical tablets, wherein the system comprises containers that are configured for receiving the compressed tablets discharged from the tablet press. Moreover, the system comprises an intermediate storage area with at least two storage spaces, a handling system that transfers the containers into the intermediate storage area and removes them from the intermediate storage area, as well as a system control unit controlling the handling system, wherein in the system control unit product-specific hardening periods can be stored or are stored, and the system control unit records the contents of a container, the storage space assigned to a container in the intermediate storage area, as well as the start of the hardening period and, at the end of the hardening period, actuates the handling system for removal of the corresponding container from the intermediate storage area and transfer to further processing.

The system comprises thus a handling system that, controlled by a system control unit, automatically transfers containers into the intermediate storage area or removes them from the intermediates storage area. The containers filled with the compressed tablets remain during the respective product-specific hardening period, which is stored in the system control unit, in the intermediate storage area. The compressed tablets can harden during a specified hardening period in the intermediate storage area. Not until they are in the hardened state, when the tablets exhibit a high mechanical strength and are no longer subject to change in size by shrinkage or expansion, are they removed by the handling system from the intermediate storage area and supplied to the coater. The handling system enables in this context a completely automated handling of the containers. Manual action is not required. The corresponding system thus ensures that the hardening period is observed for the compressed tablets in a container before the compressed tablets are provided with a coating in the coater.

Advantageously, the system comprises a detection unit that determines the quantity of the compressed tablets in a container based on the number of pieces or based on weight. Thereby it can be determined that or when a container is filled and thus can be moved into the intermediate storage area by the handling system.

Advantageously, the tablet press has downstream thereof a deflector that guides the compressed tablets discharged from the tablet press selectively to one of two or more filling stations, wherein the filling stations can be provided with a container. In this way, a practically continuous operation can be enabled. A container can be connected to each filling station. Accordingly, a container which is arranged at a filling station can be filled while a second empty container is arranged at a further filling station. After the first container has been filled to a sufficient level, which is determined preferably by the detection unit based on the number of pieces or based on weight, the deflector is preferably switched by the system control unit so that it diverts the compressed tablets to a different filling station to which a second empty container is connected. The handling system now removes, controlled by the system control unit, the first filled container from the filling station and transfers it to a storage space in the intermediate storage area. The compressed tablets can now harden in the intermediate storage area for the length of the hardening period stored in the system control unit. The number of storage spaces to be provided in the intermediate storage area is determined in this context by the required hardening period as well as the processing speed of the coater or of the tablet press. In order to enable a continuous operation of the coater or of the tablet press, a container must be regularly removed from the intermediate storage area, connected to the coater, and emptied into the coater. The hardening period of the compressed tablets in the intermediate storage area determines thus the required number of storage spaces.

After elapse of the product-specific hardening period, the handling system picks up the filled container with hardened compressed tablets from its storage space in the intermediate storage area and docks the container to an inlet opening of the coater. Preferably, the handling system is designed such that it can actuate a closure device, for example, a pivotable flap, connected to the container and/or the coater, in order to open the corresponding closure and to initiate thus the filling process automatically. After a short flow phase, when the compressed tablets have flowed from the container into the coater and the container is empty, the handling system closes the aforementioned closure device and removes the container from the coater. The empty container is now ready again to be filled with compressed tablets. The handling system can move this empty container to an empty filling station in the area of the tablet press. Alternatively, the container can also be deposited at a storage location in the intermediate storage area until it is moved for renewed filling to a filling station.

Advantageously, the container comprises an inlet opening that is automatically selectively openable and closeable in a dust-tight way. It is preferably configured to be operated by the handling system. Accordingly, the container can be automatically opened or closed. By use of the openings that are openable and closable in a dust-tight way, a contact of the compressed tablets with the environment is prevented. No contact with an operator takes place so that the system can be operated in an automatic sealed operation. On the one hand, an optimal product protection relative to contaminants acting from the exterior and, on the other hand, a protection of the environment from contamination with the active ingredients contained in the compressed tablets is realized.

Preferably, the system comprises a dust removal device for removing dust of the compressed tablets. In this way, dust can be removed from the compressed tablets and it can be ensured that only completely shaped compressed tablets will reach further processing in the system. In this way, reliability of the system is increased.

It is particularly preferred that the dust removal device is arranged between the tablet press and the deflector. In this way, only one dust removal device is required for a tablet press because dust removal from the compressed tablets is realized prior to the flow of the compressed tablets being guided by the deflector to different filling stations.

In favor of a configuration of the container that is as simple as possible and thus economic, it can be provided that it comprises only a single opening. The latter serves, on the one hand, as an inlet opening when the container is arranged at the filling station and is filled with compressed tablets and, on the other hand, as an outlet opening when the container is connected to the coater and the hardened compressed tablets are emptied from the container into the coater.

Particularly preferred, the container however has in addition to the inlet opening an outlet opening that can be selectively opened or closed automatically in a dust-tight way. Preferably, it is designed such that opening and closing of the outlet opening can be realized by the handling system. The outlet opening is designed such that it can be connected to the inlet opening of the coater. In this way, a particularly gentle handling of the compressed tablets is enabled because in this way the orientation of the container can be maintained and the container, for example, must not be rotated by 180° in order to enable filling of the container from the top and, on the other hand, discharging of the compressed tablets in downward direction into the coater.

Advantageously, all inlet and outlet openings of the system, in particular at the container itself or at devices to which the container is to be connected, can be designed as locks that can be opened and closed in a dust-tight way so that a sealed handling of the compressed tablets can be ensured.

One embodiment of the innovation will be explained in the following in more detail with the aid of the purely schematic illustrations. It is shown in:

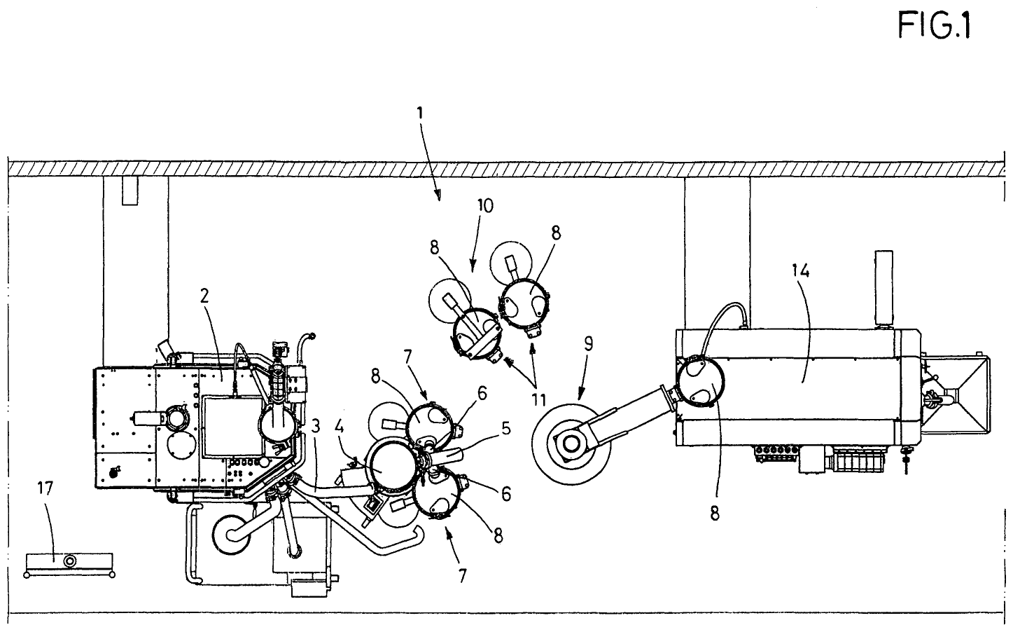

FIG. 1 a plan view of a system for producing pharmaceutical tablets, and

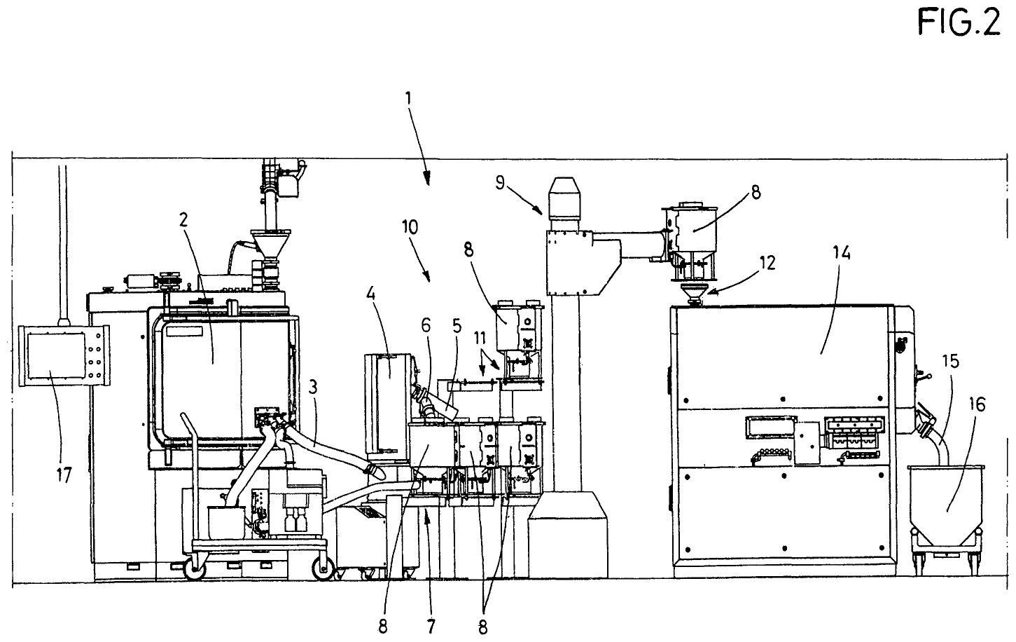

FIG. 2 a side view of the system of FIG. 1.

In the drawings, the system that is serving for producing pharmaceutical tablets is referenced as a whole by 1. The compressed tablets pass from a tablet press 2 through an outlet conduit 3 to a dust removal device 4. After the compressed articles have been freed from dust in this dust removal device 4, they reach a deflector 5 which guides the flow of compressed tablets selectively to one of two discharge channels 6. Each one of these two discharge channels 6 leads to a filling station 7 wherein in FIG. 1 it is illustrated that at each one of the two filling stations 7 one container 8 is arranged, respectively, and connected to one of the two discharge channels 6, respectively. In this way, one of the two containers 8 is filled at one filling station 7 with tablets while the second container 8 at the second filling station 7 remains empty and is instead in a standby position.

After a container 8 has been filled at filling station 7 and the deflector 5 redirects the following tablet flow into the other container 8 at the other filling station 7, the filled container 8 can be engaged by a handling system 9 and moved to an intermediate storage area 10. In the illustrated embodiment, in particular with the aid of FIG. 2 it can be seen that the intermediate storage area 10 has four storage spaces 11 wherein the two lower storage spaces 11 are filled with a container 8, respectively, while of the two upper storage spaces 11 only the one illustrated to the right is filled with a container 8 while the storage space 11 to the left is empty. Namely, the handling system 9 has engaged the container 8 that has been located at this storage space 11 initially and, as shown in FIG. 1 and FIG. 2, has moved this filled container 8 to an inlet opening 12 of the coater 14. Compressed tablets which are contained in the container 8 and have hardened during the storage duration in the intermediate storage area 10 can accordingly be filled from the container 8 into the coater 14. During this flow phase, the handling system 9 can move a filled container 8 from the filling station 7 to the free storage space 11 and, subsequently, after the hardened compressed tablets from the container 8 have flowed into the coater 14, the handling system can engage the now empty container 8 and move it to the now unoccupied filling station 7 while in the meantime the other empty container 8, initially in the standby position, is filled at the second filling station 7 with the compressed tablets coming from the dust removal device 4.

The tablets which have been coated in the coater 14 pass through a filling conduit 15 into a transport container 16 wherein the filling conduit 15 is connected dust-tightly to the coater 14 and to the transport container 16 so that, as a whole, from the tablet press 2 to the transport container 16, a closed dust-tight handling of the product in the system 1 is ensured.

The system 1 comprises a schematically indicated system control unit 17 which controls and synchronizes the individual actions of the system 1. For example, at the exit of the tablet press 2 or of the dust removal device 4, a detection device is provided which, either by means of the weight and or by means of detecting the number of pieces of the individual compressed tablets, determines the tablet quantity which is discharged by discharge channel 6 into a container 8 located at the filling station 7. As a function of the signals of these detection devices, the system control unit 17 controls the deflector 5 in order to redirect the tablet flow selectively to one of the two discharge channels 6. Furthermore, the system control unit 17 controls the handling system 9 in order to effect handling of the individual containers 8 between a filling station 7, a storage space 11, and the coater 14 as well as from the coater 14 to the filling station 7 as well as have the handling system 9 actuate closure members at the dust-tight locks which are provided at the inlet openings and/or outlet openings of the individual devices of the system 1.

What is claimed is:

1. Method for producing pharmaceutical tablets in which compressed tablets are compressed and provided with a coating, characterized in that the compressed tablets, before they are provided with the coating, are stored for a product-specific hardening period in an intermediate storage area (10) and, subsequently, are automatically removed from the intermediate storage area (10) for further processing, wherein a system control unit (17) in which the product-specific hardening periods can be stored or are stored, records the point in time of introducing the compressed tablets into the intermediate storage area (10) and, at the end of the product-specific hardening period, initiates the automatic removal of the compressed tablets.

2. Method according to claim 1, characterized in that compressed tablets with identical hardening period are moved into one container (8) and the container (8) is transferred by a handling system (9) into the intermediate storage area (10).

3. Method according to claim 2, characterized in that the container can be transferred to one of at least two storage spaces (11) in the intermediate storage area (10), wherein the system control unit records the container contents and the storage space (11) in the intermediate storage area (10), and the container (8), at the end of the stored product-specific hardening period, is automatically removed by the handling system (9), controlled by the system control unit (17), from the storage space (8) in the intermediate storage area (10).

4. Method according to claim 2, characterized in that the container (8) removed from the intermediate storage area (10) is docked to an inlet opening (12) of a coater (14) and the compressed tablets are emptied from the container (8) into the coater (14).

5. Method according to claim 1, characterized in that in the intermediate storage area (10) simultaneously compressed tablets with different hardening periods are stored.

6. Method according to claim 5, characterized in that the different compressed tablets remain within the intermediate storage area (10) for hardening periods of different lengths.

7. Method according to claim 1, characterized in that the production of the compressed tablets is realized continuously at least in parts.

8. Method according to claim 1, characterized in that dust is removed from the compressed tablets.

9. System for producing pharmaceutical tablets, with at least one tablet press (2), with at least one coater (14) arranged downstream of the tablet press (2) and providing the compressed tablets formed in the tablet press (2) with a coating, for performing the method according to claim 1, characterized in that the system comprises containers (8) which are configured for receiving compressed tablets discharged from the tablet press (2), the system comprises an intermediate storage area (10) with at least two storage spaces (11), the system comprises a handling system (9) transferring a container (8) into the intermediate storage area (10) and removing it from the intermediate storage area (10), and the system comprises a system control unit (17) controlling the handling system (9), wherein in the system control unit (17) product-specific hardening periods can be stored or are stored, and the system control unit (17) detects the contents of a container (8), the storage space (11) assigned to a container (8) in the intermediate storage area (10), as well as the start of the hardening period, and, at the end of the hardening period, controls the handling system (9) for removal of the corresponding container (8) from the intermediate storage area (10) and supply to further processing.

10. System according to claim 9, characterized in that it comprises a detection unit which determines the quantity of the compressed tablets contained in a container (8) based on the number of pieces and/or based on weight.

11. System according to claim 9, characterized in that a deflector (5) is arranged downstream of the tablet press (2) which guides the compressed tablets discharged from the tablet press (2) selectively to one of at least two filling stations (7), wherein the filling stations (7) can be provided with a container (8).

12. System according to claim 9, characterized in that the containers (8) comprise an inlet opening (12) that is selectively openable or closable automatically in a dust-tight way.

13. System according to claim 9, characterized in that the coater (14) comprises an inlet opening (12) that is selectively openable or closable automatically in a dust-tight way.

14. System according to claim 9, characterized in that the system comprises a dust removal device (4) for removing dust from the compressed tablets.

15. System according to claim 14, characterized in that the dust removal device (4) is arranged between the tablet press (2) and the deflector (5).
